(19) United States
(12) Patent Application Publication
(10) Pub. No.: US 2020/0018608 A1
(43) Pub. Date: Jan. 16, 2020

(54) METHOD AND DEVICE FOR OPERATING A VEHICLE

(71) Applicant: Robert Bosch GmbH, Stuttgart (DE)

(72) Inventors: Holger Mielenz, Ostfildern (DE); Jan Rohde, Stuttgart (DE)

(21) Appl. No.: 16/495,880

(22) PCT Filed: Jan. 25, 2018
(86) PCT No.: PCT/EP2018/051795

§ 371 Date: Sep. 20, 2019

(30) Foreign Application Priority Data
Mar. 22, 2017 (DE) 10 2017 204 839.5

(51) Int. Cl. G01C 21/32

(52) U.S. Cl. CPC G01C 21/32

(57) ABSTRACT

A method and a first device for creating and providing a highly accurate map, including a step of receiving surroundings data values, which represent surroundings of an automated vehicle, the surroundings of the automated vehicle including at least one surroundings feature and the surroundings data values including an assessment of the at least one surroundings feature, including the step of reading in of map data values, which represent a first map, the first map including the at least one surroundings feature, including a step of creating the highly accurate map based on the map data values and as a function of the assessment of the at least one surroundings feature, including the step of providing the highly accurate map. In addition, a second device for assessing and transmitting surroundings data values, including a surroundings sensor system for detecting the surroundings data values, which represent surroundings of an automated vehicle, the surroundings of the automated vehicle including at least one surroundings feature, including assessment means for creating an assessment of the at least one surroundings feature as a function of the detection of the surroundings data values, and including a transmitting unit for transmitting the surroundings data values, the surroundings data values including the assessment of the at least one surroundings feature.

### FIELD OF THE INVENTION

The present invention relates to a method and a device for creating and providing a highly accurate map, including a step of receiving surroundings data values, including a step of reading in map data values, a step of creating the highly accurate map and a step of providing the highly accurate map.

### SUMMARY

The method according to the present invention for creating and providing a highly accurate map includes a step of receiving surroundings data values, which represent surroundings of an automated vehicle, the surroundings of the automated vehicle including at least one surroundings feature and the surroundings data values including an assessment of the at least one surroundings feature, and a step of reading in map data values, which represent a first map, the first map including the at least one surroundings feature. The method further includes a step of creating the highly accurate map based on the map data values and as a function of the assessment of the at least one surroundings feature, and a step of providing the highly accurate map.

A first map and/or a highly accurate map is/are understood to mean a digital map, which is available in the form of (map) data values on a memory medium. The first and/or highly accurate map is/are designed in such a way, for example, that one or multiple map layers are included, one map layer showing, for example, a map from a bird's eye view (course and position of roads, buildings, landscape features, etc.). This corresponds to a map of a navigation system, for example.

Another map layer includes, for example, a radar map, the at least one surroundings feature encompassed by the radar map being stored with a radar signature. Another map layer includes, for example, a LIDAR map, the at least one surroundings feature encompassed by the LIDAR map being stored with a LIDAR signature.

Another additional and/or alternative map layer includes, for example, temporary conditions in surroundings of the at least one surroundings feature such as, for example, precipitation and/or fog and/or lighting conditions.

The first and/or the highly accurate map is/are designed in such a way that they are suitable for navigating a vehicle, in particular, an automated vehicle. For this purpose, the individual map layers include, for example, the at least one surroundings feature with its GPS position, this position being highly accurately known. A highly accurate position is understood to mean a position, which is accurate in such a way that an operating of an automated vehicle is possible as a function of this position. This is understood to mean, for example, an inaccuracy of the position of less than 10 cm.

An automated vehicle is understood to mean a semi-automated, highly-automated or fully-automated vehicle.

The method according to the present invention has the advantage that the highly accurate map is created in such a way that surroundings features, in particular, are included, which have previously been assessed by the use of an (automated) vehicle. Thus, using the highly accurate map for navigating an automated vehicle enhances the safety of the automated vehicle and/or of the occupants and/or the safety of other vehicles and/or of other road users in the surroundings of the vehicle.

The surroundings data values are preferably detected with the aid of a surroundings sensor system of the automated vehicle and the at least one surroundings feature is assessed as a function of the detection of the at least one surroundings feature.

This yields the advantage that a detailed assessment of whether the at least one surroundings feature is able to be detected is available, as a result of which the creation of the highly accurate map is adapted to the surroundings sensor system of the automated vehicle and/or to at least one additional surroundings sensor system of at least one additional (automated) vehicle, whereby the safety when using the highly accurate map is enhanced.

A surroundings sensor system is understood to mean one or multiple cameras and/or one or multiple radar sensors and/or one or multiple LIDAR sensors and/or one or multiple ultrasonic sensors. The surroundings sensor system further includes, for example, an evaluation unit (for example, a processing unit including a processor, working memory, a hard disk and suitable software) in order to evaluate the detected surroundings data values and to determine the at least one surroundings feature and/or the position of the at least one surroundings feature.

The at least one surroundings feature is understood to mean any feature that is suitable to be detected with the aid of a surroundings sensor system of the automated vehicle such as, for example, infrastructure features (traffic signs, lane markings, signal systems, safety-relevant features, etc.) and/or structures (buildings, bridges, tunnels, etc.) and/or landscape features (flora, mountains, lakes, rivers, etc.) and/or additional features, which are designed, for example, to be used for determining the position of an (automated) vehicle.

The at least one surroundings feature is preferably assessed as a function of a surroundings condition of the surroundings of the automated vehicle.

This is particularly advantageous, since the surroundings condition, in particular, may have a significant influence on whether the at least one surroundings feature is or is not able to be detected, as a result of which the highly accurate map is also created as a function of a temporary assessment of the at least one surroundings feature.

The surroundings condition preferably includes a weather condition and/or brightness and/or a vegetation condition and/or a building development condition.

A weather condition is understood to mean, for example, whether precipitation (rain, snow) and/or fog is/are present.

Brightness is understood to mean, for example, whether it is bright or dark (for example, due to the time of day) and/or whether it is overcast due to clouds and/or whether it is not possible to detect the at least one surroundings feature with the aid of a surroundings sensor system due to solar radiation.

In one particularly preferred specific embodiment, the highly accurate map is created by the highly accurate map including the at least one surroundings feature and the assessment of the at least one surroundings feature or by the highly accurate map not including the at least one surroundings feature.

This yields the advantage that the highly accurate map includes, for example, only surroundings features on the basis of which an automated vehicle may be operated. This allows the highly accurate map, for example, to manage with less memory requirement and to thus be transmitted, for example, more rapidly to the automated vehicle and/or to at least one other (automated) vehicle. If the highly accurate map includes the at least one surroundings feature with an assessment of the at least one surroundings feature, it is possible, for example, to provide the highly accurate map in such a way that the highly accurate map includes or does not include the at least one surroundings feature as a function of a surroundings condition (weather condition and/or brightness and or vegetation condition and/or building development condition).

The highly accurate map is preferably provided in such a way that the automated vehicle and/or at least one additional vehicle is/are driven in an automated manner as a function of the highly accurate map.

This yields the advantage that the highly accurate map is provided, for example, in such a way that the highly accurate map may be used directly by a navigation system and/or by a control unit and/or by a localization device and thus the automated vehicle and/or at least one additional vehicle is/are safely operated.

An operating of the automated vehicle and/or of the at least one additional vehicle is understood to mean, for example, the steering of the vehicle along a trajectory.

In one particularly preferred specific embodiment, the first map is replaced by the highly accurate map once the highly accurate map is created.

This yields the advantage that invariably only the most current and/or most accurate map is available, which is therefore always iteratively improved upon when the method is repeated, since the first map corresponds to a map already highly accurate in advance and the next highly accurate map is improved upon and/or adapted even further. This enhances the safety of the automated vehicle and/or of the at least one additional vehicle by an operation as a function of the highly accurate map.

The first device according to the present invention for creating and providing a highly accurate map includes first means for receiving surroundings data values, which represent surroundings of an automated vehicle, the surroundings of the automated vehicle including at least one surroundings feature and the surroundings data values including an assessment of the at least one surroundings feature, and second means for reading in map data values, which represent a first map, the first map including the at least one surroundings feature. The first device further includes third means for creating the highly accurate map based on the map data values and as a function of the assessment of the at least one surroundings feature, and fourth means for providing the highly accurate map.

The first means and/or the second means and/or the third means and/or the fourth means is/are preferably designed to carry out a method as described herein.

The second device according to the present invention for assessing and transmitting surroundings data values includes a surroundings sensor system for detecting the surroundings data values, which represent surroundings of an automated vehicle, the surroundings of the automated vehicle including at least one surroundings feature. The second device further includes assessment means for creating an assessment of the at least one surroundings feature as a function of the detection of the surroundings data values and a transmission unit for transmitting the surroundings data values, the surroundings data values including the assessment of the at least one surroundings feature.

The assessment means are preferably designed to create the assessment as a function of a surroundings condition of the surroundings of the automated vehicle.

### BRIEF DESCRIPTION OF THE DRAWINGS

FIG. 1 shows merely by way of example one exemplary embodiment of the first device according to the present invention.

FIG. 2 shows merely by way of example one exemplary embodiment of the second device according to the present invention.

FIG. 3 shows merely by way of example one exemplary embodiment of the method according to the present invention.

FIG. 4 shows merely by way of example a first map (FIG. 4a) and a highly accurate map (FIG. 4b).

FIG. 5 shows merely by way of example one exemplary embodiment of the method according to the present invention in the form of a flow chart.

### DETAILED DESCRIPTION

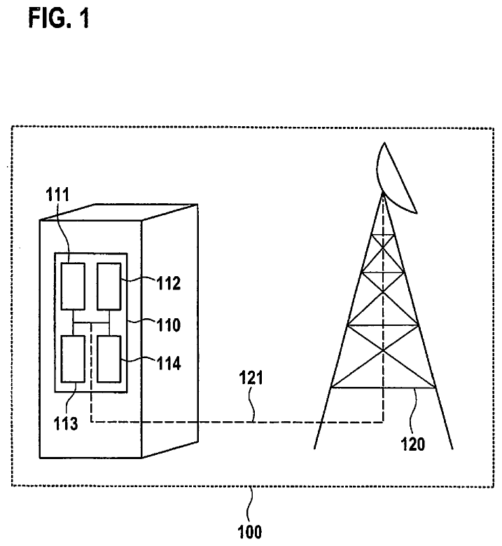

FIG. 1 shows a processing unit 100—depicted by way of example, which includes a first device 110 for creating and providing a highly accurate map 402. A processing unit 100 is understood to mean a server, for example. In another specific embodiment, a processing unit 100 is understood to mean a cloud—i.e. a combination of at least two electrical data processing systems, which exchange data with the aid of the Internet. In another specific embodiment, processing unit 100 corresponds to first device 110.

First device 110 includes first means 111 for receiving 320 surroundings data values, which represent surroundings 220 of an automated vehicle 200, surroundings 220 of automated vehicle 200 including at least one surroundings feature 221, 222 and the surroundings data values including an assessment of the at least one surroundings feature 221, 222, and second means 112 for reading in 330 map data values, which represent a first map 401, first map 401 including the at least one surroundings feature 221, 222. First device 110 further includes third means 113 for creating 340 highly accurate map 402 based on map data values and as a function of the assessment of the at least one surroundings feature 221, 222, and fourth means 114 for providing 350 highly accurate map 402.

First means 111 and/or second means 112 and/or third means 113 and/or fourth means 114 may—as a function of the respective specific embodiment of processing unit 100—be differently designed. If processing unit 100 is designed as a server, first means 111 and/or second means 112 and/or third means 113 and/or fourth means 114—relative to the location of first device 110—is/are located at the same location.

If processing unit 100 is designed as a cloud, first means 111 and/or second means 112 and/or third means 113 and/or fourth means 114 may be located at different locations, for example, in different cities and/or in different countries, a connection—such as, for example, the Internet—being designed to exchange (electronic) data between first means 111 and/or second means 112 and/or third means 113 and/or fourth means 114.

First means 111 is designed to receive surroundings data values. First means 111 in this case includes a receiving and/or transmitting unit, with the aid of which data are requested and/or received. In another specific embodiment, first means 111 is designed in such a way that the first means is connected—based on first device 110—to an externally situated transmitting and/or receiving unit 122 with the aid of a wired connection and/or wireless connection 121. First means 111 further includes electronic data processing elements, for example, a processor, working memory and a hard disk, which are designed to process surroundings data values, for example, to carry out a change and/or adaptation of the data format and to subsequently forward them to third means 113. In another specific embodiment, first means 111 is designed in such a way that the received surroundings data values—without data processing elements—are forwarded to third means 113.

The first device further includes second means 112, which is designed to read in map data values, which represent a first map 401, first map 401 including the at least one surroundings feature 221, 222. For this purpose, second means 112 also includes, for example, a hard disk, which includes first map 401. Second means 112 is further designed to transmit the read-in map data values to third means 113.

In another specific embodiment, first map 401 is requested and/or received from an external database of a map provider provided for such purpose with the aid of a transmitting and/or receiving unit of first and/or of second and/or of third and/or of fourth means 111, 112, 113, 114 or with the aid of externally situated transmitting and/or receiving means 122.

First device 110 further includes third means 113 for creating 340 highly accurate map 402 based on the map data values and as a function of the assessment of the at least one surroundings feature 221, 222. For this purpose, third means 113 includes electronic data processing elements, for example, a processor, working memory and a hard disk. Third means 113 further includes a corresponding software, which is designed to create a highly accurate map 402 based on the map data values and as a function of the assessment of the at least one surroundings feature 221, 222.

Highly accurate map 402 is created 340, for example, by expanding the data values, which represent highly accurate map 402 and the at least one surroundings feature 221, 222, to include the assessment of the at least one surroundings feature 221, 222.

In another specific embodiment, highly accurate map 402 is created 340, for example, by removing data values that represent the at least one surroundings feature 221, 222, completely or partially from the data values that represent highly accurate map 402.

First device 110 further includes third means 113 for creating 340 highly accurate map 402 based on the map data values and as a function of the assessment of the at least one surroundings feature 221, 222, and fourth means 114 for providing 350 highly accurate map 402.

First device 110 further includes fourth means 114 for providing 350 highly accurate map 402. For this purpose, fourth means 114 includes a receiving and/or transmitting unit, with the aid of which data are requested and/or received. In another specific embodiment, fourth means 114 is designed in such a way that the fourth means—originating from first device 110—is connected to externally situated transmitting and/or receiving unit 122 with the aid of a wired connection or wireless connection 121. In another specific embodiment, the transmitting and/or receiving means is/are identical to the transmitting and/or receiving means of first means 111 and/or to the transmitting and/or receiving means of second means 112.

Fourth means 114 further includes electronic data processing elements, for example, a processor, working memory and a hard disk, which are designed to process highly accurate map 402 in the form of data values, for example, to carry out a change and/or adaptation of the data format, and to subsequently provide them as highly accurate map 402.

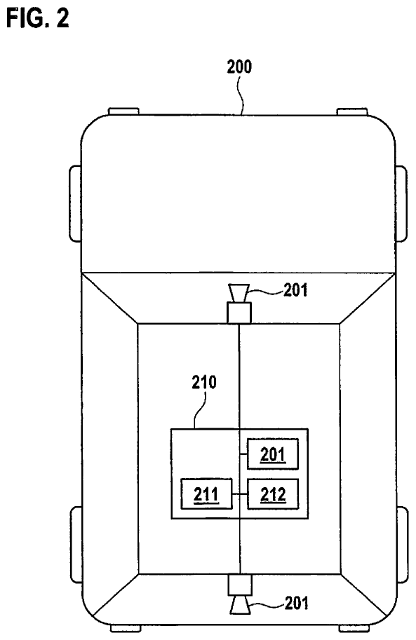

FIG. 2 shows an automated vehicle 200, which includes a second device 210 for assessing and transmitting surroundings data values.

Automated vehicle 200 in this case is designed as a passenger vehicle. In other specific embodiments, automated vehicle 200 is designed as a truck or as a two-wheeled vehicle.

Second device 210 includes a surroundings sensor system 201 for detecting the surroundings data values, which represent surroundings 220 of automated vehicle 200, surroundings 220 of automated vehicle 200 including at least one surroundings feature 221, 222, and assessment means 211 for creating an assessment of the at least one surroundings feature 221, 222 as a function of the detection of the surroundings data values. Second device 210 further includes a transmitting unit 212 for transmitting the surroundings data values, the surroundings data values including the assessment of the at least one surroundings feature 221, 222.

The surroundings sensor system 201 includes, for example, sensors and an evaluation unit, in order to evaluate the detected surroundings data values and to determine the at least one surroundings feature 221, 222 and/or the position of the at least one surroundings feature 221, 222 (for example, relative to automated vehicle 200).

In another specific embodiment, surroundings sensor system 201 is included not in second device 210, but in automated vehicle 200. In this case, second device 210 is designed to receive the surroundings data values from surroundings sensor system 201.

Second device 210 further includes assessment means 211 for creating an assessment of the at least one surroundings feature 221, 222 as a function of the detection of the surroundings data values. For this purpose, assessment means 211 includes, for example, a processing unit (processor, working memory, hard disk, as well as suitable software). The assessment of the at least one surroundings feature 221, 222 includes, for example, the piece of information that the at least one surroundings feature 221, 222 is only partly detected and/or is not detected at all, even though based on a piece of information from a map (for example, from the first map, which is included in automated vehicle 200), the at least one surroundings feature 221, 222 in surroundings 220 of vehicle 200 would have to be detected by surroundings sensor system 201. The assessment further includes, for example, a piece of information about the surroundings condition, which is also detected with the aid of surroundings sensor system 201. The assessment further includes the piece of information that the at least one surroundings feature 221, 222 is detected, but detected only in such a way that automated vehicle 200 is not localized based on the at least one surroundings feature 221, 222.

Assessment means 211 is further designed to transmit the assessment to transmitting unit 212.

Transmitting unit 212 for transmitting the surroundings data values, the surroundings data values including the assessment of the at least one surroundings feature 221, 222, is designed to receive the assessment from assessment means 211. Transmitting unit 212 is designed to transmit the surroundings data values with the aid of a radio link to first device 110.

In another specific embodiment, transmitting unit 212 is designed in such a way that the transmitting unit—originating from second device 210—is connected to an externally situated transmitting and/or receiving unit with the aid of a wired connection and/or wireless connection. This may involve a navigation system, for example, which is included in vehicle 200.

In another specific embodiment, transmitting unit 212 is designed in such a way that the transmitting unit is connected to a mobile receiving device—in particular, a smartphone. This connection may take place, for example, with the aid of a wired connection and/or a wireless connection such as, for example, Bluetooth.

In another specific embodiment, transmitting unit 212 includes electronic data processing elements, for example, a processor, working memory and a hard disk, which are designed to process the surroundings data values, for example, to carry out a change and/or adaptation of the data format and to subsequently transmit them to first device 110.

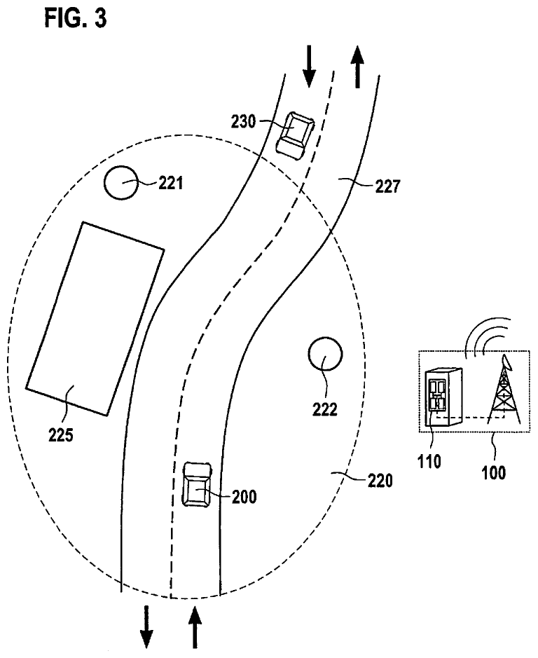

FIG. 3 shows one exemplary embodiment of a method for creating and providing a highly accurate map 402.

In this case, automated vehicle 200, which includes second device 210, is located on a two-lane road 227. Located in surroundings 220 of automated vehicle 200 are two surroundings features 221, 222, a first surroundings feature 221 being unable to be detected with the aid of a surroundings sensor system 201 of automated vehicle 200, since a building 225, for example, is located between first surroundings feature 221 and automated vehicle 200. Second surroundings feature 222 may be detected with the aid of surroundings sensor 201 of automated vehicle 200.

Automated vehicle 200 further includes a navigation system, for example, which includes a map having first and second surroundings feature 221, 222. The map is first map 401, for example, which is also included in first device 110.

In another specific embodiment, first map 401, which includes automated vehicle 200, corresponds, for example, to a previously highly accurate map, which has been received in advance by first device 110. For this purpose, transmitting unit 212 of automated vehicle 200 is designed, for example, as a transmitting and receiving unit.

First and second surroundings feature 221, 222—regarding the possibility of detecting these with the aid of surroundings sensor system 201 of automated vehicle 200—are then assessed with the aid of assessment means 211 of second device 210.

The surroundings data values that represent the surroundings of automated vehicle 200 and include the assessment of first and second surroundings feature 221, 222, are transmitted with the aid of transmitting unit 212 to first device 110 and received with the aid of first means 111 of first device 110. First map 401 in the form of map data values is read in with the aid of second means 111 and both the received surroundings data values as well as the map data values are transmitted to third means 113. A highly accurate map 402 is created with the aid of third means 113 based on the map data values and as a function of the assessment of the at least one surroundings feature 221, 222.

In the process, highly accurate map 402 is created in such a way, for example, that second surroundings feature 222 is encompassed by map 402 and first surroundings feature 221 is not encompassed by highly accurate map 402.

Highly accurate map 402 is transmitted to automated vehicle 200 and/or to at least one additional vehicle 230 with the aid of fourth means 114.

Once highly accurate map 402 is received by automated vehicle 200 and/or by the at least one additional vehicle 230, automated vehicle 200 and/or the at least one additional vehicle 230 is operated, for example, as a function of highly accurate map 402.

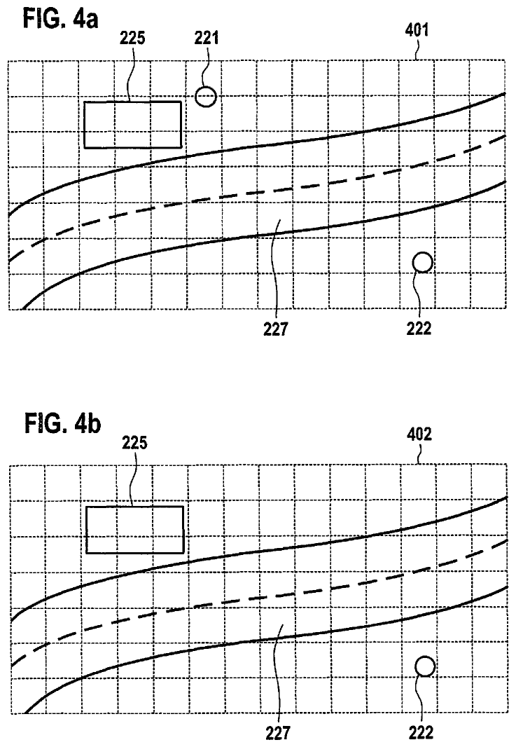

FIG. 4 shows a first map 201 (FIG. 4a) and a highly accurate map 402 (FIG. 4b), which is created based on map data values representing first map 401 and as a function of the assessment of the at least one surroundings feature 221, 222. In this case, both maps include, for example, a road 227 and a building 225. First map 401 includes a first surroundings feature 221 and a second surroundings feature 222.

Since, however, surroundings feature 221, preceding from road 227, is at least partly covered by building 225, highly accurate map 402 is created in such a way that first surroundings feature 221 is no longer included by highly accurate map 402.

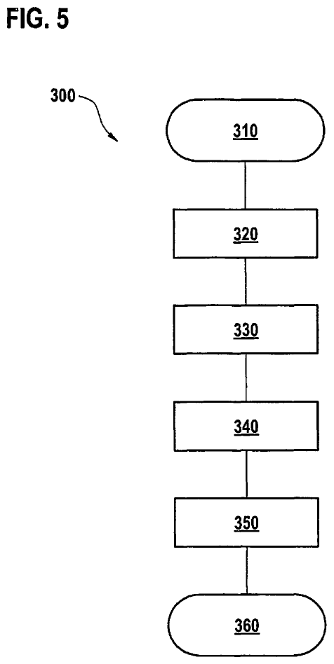

FIG. 5 shows one exemplary embodiment of method 300 according to the present invention in the form of a flow chart.

Method 300 for creating and providing a highly accurate map 402 starts in step 310.

Surroundings data values, which represent surroundings 220 of an automated vehicle 200, are received in step 320. In this step, surroundings 220 of automated vehicle 200 includes at least one surroundings feature 221, 222 and the surroundings data values include an assessment of the at least one surroundings feature 221, 222.

Map data values, which represent a first map 401, are read in in step 330, first map 401 including the at least one surroundings feature 221, 222.

Highly accurate map 402 is created in step 340 based on the map data values and as a function of the assessment of the at least one surroundings feature 221, 222.

Highly accurate map 402 is provided in step 350.

Method 300 ends in step 360.

1.-11. (canceled)

12. A method for creating and providing a highly accurate map, comprising:
receiving surroundings data values that represent surroundings of an automated vehicle, wherein the surroundings of the automated vehicle include at least one surroundings feature, and wherein the surroundings data values include an assessment of the at least one surroundings feature;
reading in map data values that represent a first map that includes the at least one surroundings feature;
creating the highly accurate map based on the map data values and as a function of the assessment of the at least one surroundings feature; and
providing the highly accurate map.

13. The method as recited in claim 12, wherein:
the surroundings data values are detected with the aid of a surroundings sensor system of the automated vehicle, and
the at least one surroundings feature is assessed as a function of a detection of the at least one surroundings feature.

14. The method as recited in claim 13, wherein the at least one surroundings feature is assessed as a function of a surroundings condition of the surroundings of the automated vehicle.

15. The method as recited in claim 14, wherein the surroundings condition include at least one of a weather condition, a brightness, a vegetation condition, and a building development condition.

16. The method as recited in claim 12, wherein the highly accurate map is created one of:
by the highly accurate map including the at least one surroundings feature and the assessment of the at least one surroundings feature, and
by the highly accurate map not including the at least one surroundings feature.

17. The method as recited in claim 12, wherein the highly accurate map is provided in such a way that at least one of the automated vehicle and at least one additional vehicle is operated as a function of the highly accurate map.

18. The method as recited in claim 12, wherein the first map is replaced by the highly accurate map after the highly accurate map is created.

19. A first device for creating and providing a highly accurate map, comprising:
first means for receiving surroundings data values that represent surroundings of an automated vehicle, wherein the surroundings of the automated vehicle include at least one surroundings feature, and wherein the surroundings data values include an assessment of the at least one surroundings feature;
second means for reading in map data values that represent a first map that includes the at least one surroundings feature;
third means for creating the highly accurate map based on the map data values and as a function of the assessment of the at least one surroundings feature; and
fourth means for providing the highly accurate map.

20. A device for assessing and transmitting surroundings data values, comprising:
a surroundings sensor system for detecting surroundings data values that represent surroundings of an automated vehicle, wherein the surroundings of the automated vehicle include at least one surroundings feature;
an assessment unit for creating an assessment of the at least one surroundings feature as a function of a detection of the surroundings data values; and
a transmission unit for transmitting the surroundings data values, wherein the surroundings data values include the assessment of the at least one surroundings feature.

21. The device as recited in claim 20, wherein the assessment unit creates the assessment as a function of a surroundings condition of the surroundings of the automated vehicle.
